(19) United States
(12) Patent Application Publication
(10) Pub. No.: US 2008/0131230 A1
(43) Pub. Date: Jun. 5, 2008

(54) Fastening System, Especially For a Heat Exchanger

(76) Inventors: Ralph Burgstein, Pleidelsheim (DE); Simone Edelmann, Stuttgart (DE); Dirk Meier, Stuttgart (DE); Andreas Rick, Leonberg (DE)

Correspondence Address: FOLEY AND LARDNER LLP;SUITE 500, 3000 K STREET NW, WASHINGTON, DC, 20007, US

(21) Appl. No.: 11/666,735

(22) PCT Filed: Nov. 3, 2005
(86) PCT No.: PCT/EP05/11765

§ 371 Date: May 2, 2007

(30) Foreign Application Priority Data
Nov. 4, 2004 (DE) 10 2004 053 851.4

(51) Int. Cl. F16B 21/00

(52) U.S. Cl. 411/342

(57) ABSTRACT

The invention relates to a fastening system (2), especially for a heat exchanger, which comprises at least three fastening units (6), substantially configured by screws (3) that are inserted through corresponding openings (8, 16) in a first structural component to be fastened on a second structural component. The fastening system is characterized in that exactly one fastening unit (6) is configured as a fixed hearing (6a) and the other fastening units (6) are configured as floating bearings (6b).

The invention relates to a fastening system, in particular for a heat exchanger, according to the precharacterizing clause of claim 1.

During the fastening of a heat exchanger, in particular in a cooling system, by attaching the same in a frame by means of four screws, stresses frequently occur which are caused due to the different thermal expansion of the heat exchanger and its frame. These stresses may result in cracks on the components. The fastening of heat exchangers in rail vehicles is particularly problematic because of the size and installation situation. As a consequence of the high loads, the service life is considerably reduced.

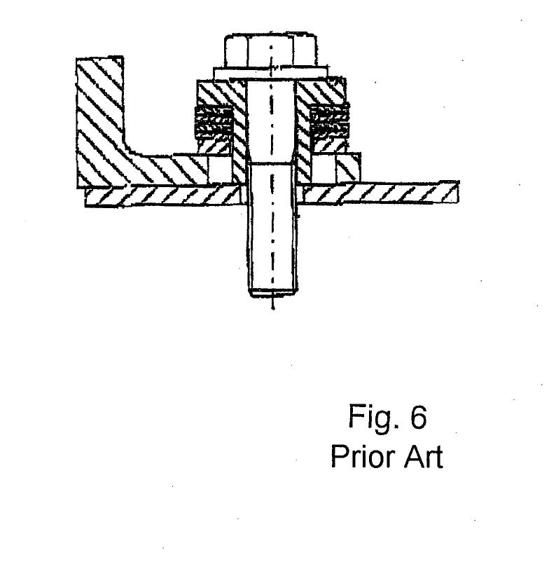

For a fastening in as stress-free a manner as possible, in the case of a known heat exchanger (cooler) relatively large bores are provided through which a screw with a bushing pushed onto the shank, spring elements, such as disk springs and stop-choc elements, and a washer is inserted, as illustrated in FIG. 6. However, a fastening of this type still leaves something to be desired.

It is the object of the invention to provide a fastening system which avoids the problems mentioned at the beginning.

This object is achieved by a fastening system with the features of claim 1. Advantageous refinements are the subject matter of the subclaims.

According to the invention, a fastening system, especially for a heat exchanger, is provided with at least three fastening units which are essentially formed by screws which are inserted through corresponding openings in a first component to be fastened to a second component, with one fastening unit being designed as a fixed bearing and the other fastening units being designed as floating bearings. Provision of a fixed bearing makes exact positioning and easy installation possible, and the floating bearings permit tolerance compensation, in particular also with regard to different thermal expansions of the two components, and therefore stress loads can be considerably reduced. Furthermore, the manufacturing tolerances with regard to the arrangement of the fastening units, in particular with regard to the angularity, can be increased.

A tolerance compensation is preferably provided in the screw insertion direction such that, in addition to being able to increase the manufacturing tolerance with regard to the arrangement of the fastening units, it is also possible to increase the tolerances with regard to the evenness of the components, as a result of which the manufacturing costs can be reduced inter alia as a result of a lower reject rate.

The tolerance compensation in the screw insertion direction is preferably formed by one or more spring elements, in particular compression springs. Other spring elements, such as, for example, disk springs, can likewise be used. Compression springs, in particular, are obtainable cost-effectively in all dimensions and for a very wide variety of forces and permit a very large tolerance.

The tolerance compensation in the screw insertion direction is preferably provided exclusively at the floating bearings, and therefore the positioning of the components is fixed by the fixed bearing.

The opening in the first component on the fixed bearing is preferably formed by a bore, since a bore can be produced very cost-effectively and in a manner such that it can be positioned and dimensioned exactly. Other forms of openings are in principle also possible.

The opening in the first component on a floating bearing is preferably formed by an elongated hole with a larger longitudinal extent than the opening on the fixed bearing or by a bore with a larger diameter than the opening on the fixed bearing. The increased openings permit a certain degree of displacement of the components in relation to each other such that different thermal expansions of the two components can be compensated for, as a result of which no stresses occur.

The fastening unit which is provided on the fixed bearing preferably has, in addition to the screw, a sleeve or bushing which is pushed onto the screw shank and bears with its end against the component. Owing to its elasticity, the sleeve or bushing permits compensation against settling and therefore serves to secure the screw connection against being released.

The fastening unit which is provided on a floating bearing preferably has, in addition to the screw, a sleeve or bushing which is pushed onto the screw shank and a spring element, in particular a compression spring, which is pushed onto the sleeve or bushing. In this case, the sleeve or bushing which is pushed onto the screw shank preferably bears with its end which is spaced apart from the screw head against the second component such that the screw and the sleeve or bushing are connected fixedly to the second component while the first component is pressed by the spring force against the second component but, as a result of the enlarged opening through which the screw and the sleeve or bushing protrudes, can be displaced relative to said second component.

The screws are preferably screwed into a mating element which is formed separately from the second component that is preferably connected fixedly to the same by means of riveting or in another manner such that the number of components is reduced and installation is possible even when there is limited accessibility to the rear side of the second component. Rivet nuts are particularly suitable. Owing to the fact that the mating element can be composed of a different material, the selection of materials for the second component is increased, since the strength for a thread does not have to be taken into consideration. The configurations can be selected as a function of the corresponding strengths.

The fastening units which have a tolerance compensation in the screw insertion direction preferably also permit a displacement perpendicular with respect to the screw insertion direction in order to compensate for the thermal expansion.

Three floating bearings are preferably provided in addition to the one fixed bearing and so an optimum, secure and preferably also standard fastening of the components to one another is possible.

The fixed bearing is preferably arranged at the top.

A fastening system of this type for heat exchangers is preferably used for coolers, in particular in rail vehicles.

The invention is explained in detail below using an exemplary embodiment and with reference to the drawing, in which:

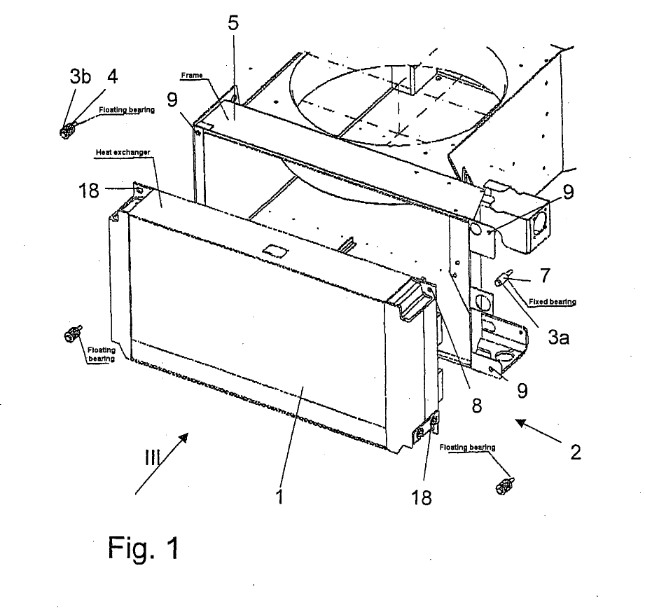

FIG. 1 shows a perspective exploded illustration of a fastening system for a cooler for fastening the same to a frame in accordance with the exemplary embodiment,

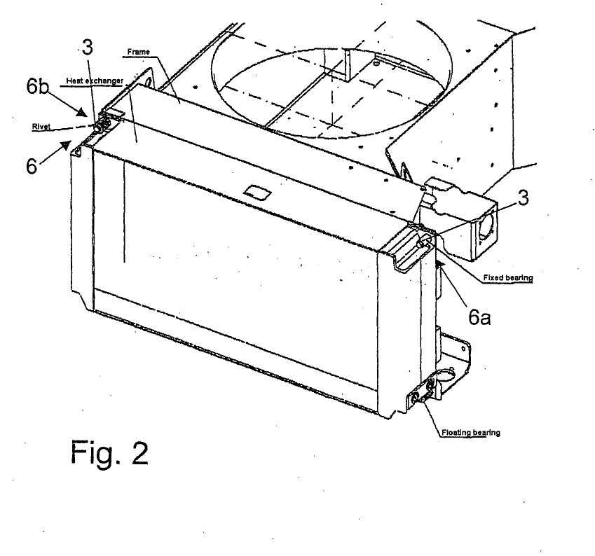

FIG. 2 shows the fastening system of FIG. 1 in a perspective, assembled illustration,

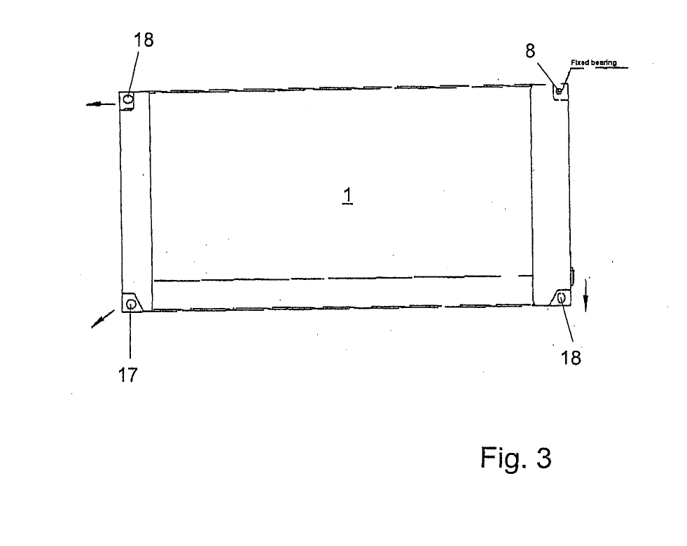

FIG. 3 shows a view of the cooler in the direction of the arrow III from FIG. 1 showing the play (illustrated schematically by arrows) of the three floating bearings,

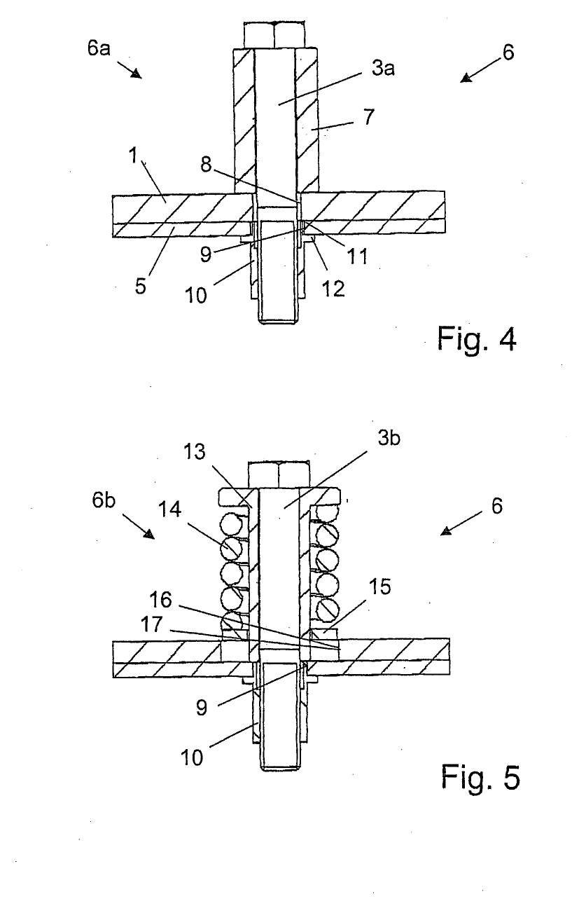

FIG. 4 shows a section through the fixed bearing,

FIG. 5 shows a section through a floating bearing, and

FIG. 6 shows a section through a fastening in accordance with the prior art.

A heat exchanger, in the present case a cooler 1 of a rail vehicle, is attached to a frame 5 by means of a fastening system 2 which essentially comprises four screws 3 and three spring elements 4 assigned to three of the four screws 3. The fastening system 2 therefore comprises four fastening units 6 which, as is apparent from FIGS. 1 to 3, are arranged at the four corners of the cooler 1 and of the frame 5.

In the present case, the fastening unit 6, which is illustrated at the top on the right in FIGS. 1 to 3 and in FIG. 4, forms the fixed bearing 6a in which no or only a small amount of play within the context of tolerances is provided while the other three fastening units 6 are floating bearings 6b which have a tolerance compensation as a consequence of unevenesses of the frame 5 and/or of the cooler 1 and have a play in the directions illustrated by arrows in FIG. 3, for differing thermal expansion of cooler 1 and frame 5.

The fastening unit 6 forming the fixed bearing 6a is illustrated in detail in FIG. 4. In this case, a first screw 3a is inserted through a sleeve 7 which, at its end opposite the screw head, bears against the edge region of an opening or bore 8 in the cooler 1. The bore 8 has a somewhat larger inside diameter than the shank diameter of the screw 3a. In alignment with the bore 8, a further bore 9 is provided in the frame 5, into which bore a mating element 10 which serves as a nut and is provided with an internal thread—in the present case a rivet nut—protrudes with an end region 11, the end region 11 being free from an internal thread and having a larger inside diameter than the shank diameter of the screw 3a. In this case, the inside diameter corresponds approximately to the inside diameter of the bore 8 in the cooler 1. As a result of production, a bead 12 which bears against the frame 5 is provided on the mating element 10. The internal thread of the mating element 10 begins only after the bead 12 (cf. FIG. 4). Instead of the mating element 10 described here, use can also be made of a conventional nut.

A fastening unit 6 forming one of the three floating bearings 6b is illustrated in detail in FIG. 5. In this case, a screw 3b, which, in the present case, has the same diameter as the screw 3a of the fastening unit 6 on the fixed bearing 6a but is manufactured from a material which has a greater degree of elasticity, is inserted through a bushing 13 into which the spring element 4, in the present case a compression spring 14, is placed, with the inside diameter of the compression spring 14 being a sufficient degree larger than the outside diameter of the bushing 13. A washer 15 is arranged downstream of the compression spring 14 and bears with its side lying opposite the compression spring 14 against the edge region of the corresponding opening 16 in the cooler 1. In the present case, the opening 16 is formed by a bore 17 that has a significantly larger inside diameter than the shank diameter of the screw 3b and the outside diameter of the bushing 13. The bushing 13 protrudes through the washer 15 and the bore 17 and bears against the frame 5. A bore 9 is provided in the frame 5 aligned with the bore 17 in the state illustrated, said bore 9 corresponding to the bore 9 in the case of the fixed bearing 6a, into which—likewise in accordance with the fixed bearing 6a—a mating element 10 (rivet nut) protrudes with an end region 11.

The provision of the spring element 4 permits a tolerance compensation of unevenesses of the cooler 1 and/or of the frame 5. By means of the configuration of the openings 16, a compensation of different thermal expansions of the cooler 1 and of the frame 5 in the direction of the arrows of FIG. 3 is possible, with no displacement of the cooler 1 in relation to the frame 5 being possible in the region of the fixed bearing 6a.

The opening 16 at the other two corners are designed as elongated holes 18 (cf. FIG. 3), and therefore essentially only a longitudinal displacement is possible in order to compensate for the thermal expansion, a section through one of the floating bearings 6b looking along the longitudinal axis of the elongated hole 18 according to FIG. 5.

1. A fastening system, especially for a heat exchanger, with at least three fastening units which are essentially formed by screws which are inserted through corresponding openings in a first component to be fastened to a second component, wherein one fastening unit is designed as a fixed bearing and the other fastening units are designed as floating bearings.

2. The fastening system as claimed in claim 1, wherein a tolerance compensation is provided in the screw insertion direction.

3. The fastening system as claimed in claim 2, wherein the tolerance compensation in the screw insertion direction is formed by one or more spring elements, in particular compression springs.

4. The fastening system as claimed in claim 1, wherein a tolerance compensation in the screw insertion direction is provided exclusively at the floating bearings.

5. The fastening system as claimed in claim 1, wherein the opening on the fixed bearing is formed by a bore.

6. The fastening system as claimed in claim 1, wherein the opening on the floating bearings is formed by an elongated hole with a greater longitudinal extent than the opening on the fixed bearing or by a bore with a larger diameter than the opening on the fixed bearing.

7. The fastening system as claimed in claim 1, wherein the fastening unit which is provided on the fixed bearing has, in addition to the screw, a sleeve or bushing which is pushed onto the screw shank and bears with its end against the first component.

8. The fastening system as claimed in claim 1, wherein the fastening unit which is provided on a floating bearing has, in addition to the screw, a sleeve or bushing which is pushed onto the screw shank, and a spring element, in particular a compression spring, which is pushed onto the sleeve or bushing.

9. The fastening system as claimed in claim 8, wherein the sleeve or bushing which is pushed onto the screw shank bears with its end against the second component.

10. The fastening system as claimed in claim 1, wherein the fastening units on the fixed bearing and the floating bearings have screws with differing elasticity.

11. The fastening system as claimed in claim 10, wherein the screw at the fixed bearing has a lower elasticity than the screws at the floating bearings.

12. The fastening system as claimed in claim 1, wherein the screw is screwed into a rivet nut which is riveted into the second component.

13. The fastening system as claimed in claim 1, wherein the fastening units which have a tolerance compensation in the screw insertion direction also permit a displacement perpendicular to the screw insertion direction in order to compensate for the thermal expansion.

14. The fastening system as claimed in claim 1, wherein three floating bearings are provided.

15. The fastening system as claimed in claim 1, wherein the fixed bearing is arranged at the top.
